(19) United States
(12) Patent Application Publication
(10) Pub. No.: US 2009/0048981 A1
(43) Pub. Date: Feb. 19, 2009

(54) SiteWare a 3D (x,y,z dimensions) 4D (time;past(s), present future(s)) & 5D (Business Rules) infrastructure business intelligence and configuration management solution managing all enterprise physical and logical assets characteristics and relationships

(76) Inventor: Jorge Indalecio McBain Millan, Bogota, NJ (US)

Correspondence Address: Jorge I. McBain, 141 Pallsade Avenue, Bogota, NJ, 07603-1615, US

(21) Appl. No.: 11/889,914

(22) Filed: Aug. 17, 2007

(51) Int. Cl. G06Q 40/00; G06Q 10/00

(52) U.S. Cl. 705/36 R

(57) ABSTRACT

SiteWare™ is a 3D (C28), (C30), (C32) infrastructure business intelligence web-based knowledge system, (C10), (C12), (C14), (C16), (C18), (C20), (C22) which dynamically allows company directors, managers, engineers, technicians, and other infrastructure users and service providers to have a centralized visual portal where all can communicate, collaborate and share consistent data of your Logical and Physical infrastructure assets (F1), (F2), (F3), (F4), (F5), (F6), (F7), (F8), (F8), (F9), (F10), (F11). SiteWare™ allows you to dynamically visualize all assets logically and physically, their past; present (F1), future (F2), as well as interrelations within projects (F2), activities, relationships, documents (F3), dependencies, responsibilities, achievements, installation control, procurement, along with an automatic documentation capability. SiteWare™ will inform you how such events will affect your business, organization, infrastructure, resources, space, and your total cost of ownership.

### THERE IS NO CROSS-REFERENCE TO THIS APPLICATION

### FEDERALLY SPONSORED RESEARCH

Not applicable

### SEQUENCE LISTING OR PROGRAM

software program to be included here, details?

### BACKGROUND—TECHNICAL FILED OF INVENTION

The present invention relates to a computer method and system for managing in their past, present and future all the enterprise physical and logical assets relationships, which dynamically allows infrastructure users and service providers to have a centralized visual portal where all can communicate, collaborate and share consistent data of said logical and physical infrastructure assets.

### BACKGROUND OF THE INVENTION

The Infrastructure industry relies heavily in static and unrelated information, some more reliable than others but static, such as paper, file(s), desk station oriented limited capabilities data Applications, etc. Such multiple sources of information about physical and logical assets within a Facility Infrastructure, makes difficult the visualization of all possible relationships between physical and logical facility components.

Besides, there are usually many parties working on the facility, which may cause lack of communication and collaboration. There is no real-time help, nor real-time visualization of all actions happening within the infrastructure, or analytic that allows business owners in all levels to make decisions to enhance their investments, cash flow, productivity, time, errors and more importantly consistency through any deliverables that they may have.

In summation, several currently existing problems have to be considered for physical and logical assets:

Multiple unrelated Sources of information about the Facility Infrastructure.

Lack of collaboration/communication amongst the various parties working on the Facility.

Lack of timely feedback and documentation about problems to be addressed.

Lack of ability to visualize the relationships between Facility components.

No Single Source of Real-Time status of projects and budgets.

No common understanding of past, current and future changes.

No Real-Time reporting capability of known issues.

### SUMMARY OF THE INVENTION

In general, the concept of this invention is to introduce a set of sophisticated capabilities that not only allow managers and end-users at any level to visualize holistically all their infrastructure assets, but to also have a built in process that integrates corporate infrastructure work flow with the 3d (x,y,z), 4d (time) and 5D (business rules) asset visualization.

Concept of a holistic visualization of corporate infrastructure assets integrated with information workflow, increases by orders of magnitude levels of control, information sharing and detailed knowledge of the infrastructure assets across the domain at any level, to system and program managers at the operational level (FIG. 14).

The net result of the invention's object oriented 3d, 4d and 5D presentation of the corporate infrastructure is a set of smart information showing interdependencies providing data horizontally and vertically to all stakeholders throughout the life-cycle of the corporate structure. Lastly, each component object is displayed as a 3D graphic XML object, that allows stakeholders and communities of interest to see (visualize) how an object will ‘live, fit, interrelate, function’ within a virtual, physical and logical space of the projected infrastructure complex.

By starting managers were able to leap ahead of older product concepts that present information as flat unrelated data that does not provide knowledge of itself, other or others corporate assets; the system delivers not only physical and logical asset visualization, but also a logic engine and routines that define the business rules unique to that infrastructure and enterprise. This business rules engine ensures asset managers to act and manage the infrastructure in line with how the corporation does business. The system delivers critical and non-critical infrastructure information the way that managers understand, work, think and plan to ensure systems availability, effective control of enterprise infrastructure physical and logical 3d Infrastructure assets as correlates to their past, today and future actions, reactions and relationships. This WEB object model of the invention reduces inefficiencies as well as mitigating risk throughout all phases of a future project. This intelligent information ensures all participants and trade partners to visualize the same information and interdependencies of all physical and logical objects and how any change in the infrastructure will produce a “ripple effect” across the enterprise informing manager's, owners and related parties intelligently any changes within itself.

### DRAWINGS—FIGURES

Color drawings are needed in order to specifically illustrate and denote the dynamics, interrelations, communication and collaboration between all applications in 3 dimensions. (B&W media will not deliver the message clearly)

FIG. 1 illustrates the interrelation, interconnection and the disperse information to all participants through Intranet or Extranet.

FIG. 2 illustrates the propagation of the alarms to suitable participants.

FIG. 3 illustrates the Current Site Viewer F1, and within the set of applications which provides the fundamental support and tools for Asset Editor, providing the fundamental support to set up and configure all physical characteristics of objects with shapes.

FIG. 4 illustrates the Future Changes F2, and within the set of applications, which provides the fundamental support and tools to build and follow all workflow and processes needed within a future model of a site.

FIG. 5 illustrates the Documents F3, and within the set of applications which provides the fundamental support and tools to edit documents and configure their Life Cycle, which enrich the information stored in SiteWare™

FIG. 6 illustrates Live Notes F4, and within the set of applications which provides the fundamental support and tools to Track notes and escalate procedures to finally enrich the information stored in SiteWare™ by linking assets to all communications (notes, discussions, attachments, . . . ) pertaining to the assets.

FIG. 7 illustrates My SiteBoard Business F5, and within the set of applications which provides the fundamental support and tools to create and configure the means of Monitoring Mechanism, keeps users aware of situations that are important to them in real-time.

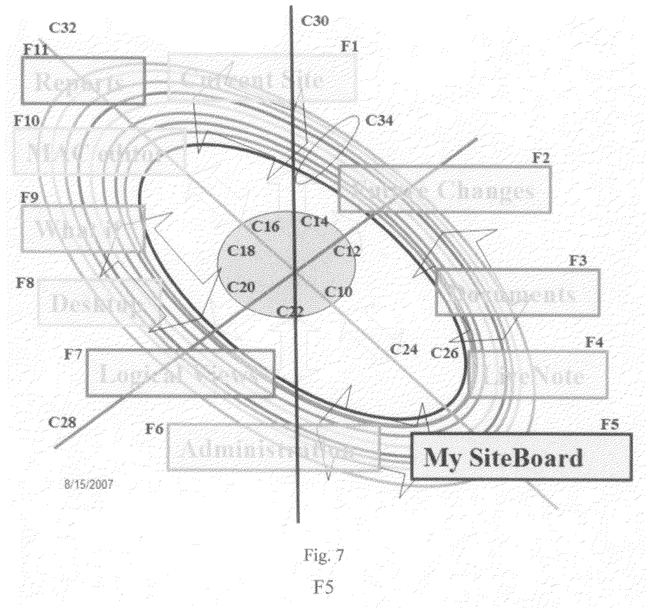

FIG. 8 illustrates Overall system Administration F6, and within the set of applications which provides the fundamental support and tools to empower administrators to configure and adapt SiteWare™ to operate in coherence with the business rules in the users' environments.

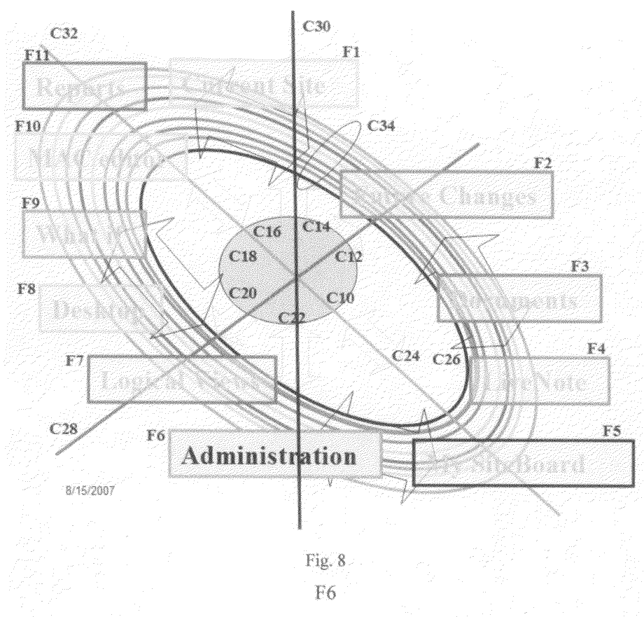

FIG. 9 illustrates Logical Views F7, and within the set of applications, which provides the fundamental support and tools to Edit/View Dynamic logical views, helps users to understand complex site configuration.

FIG. 10 illustrates the Desktop F8, and within the set of applications which provides the fundamental support and tools to helps users to improve the efficiency in understanding customizing visually a view to understand and manipulate data.

FIG. 11 illustrates “What if” F9, and within the set of applications within providing the fundamental support and tools to allow users to simulate situations within time views.

FIG. 12 illustrates the MAC Editor F10, and within the set of applications which provides the fundamental support and tools to edit changes in 3 Dimensions and provides the user interface for creating changes to a future configuration.

FIG. 13 illustrated the Generic Report Editor F11, and within the set of applications which provides the fundamental support and tools to generate ad hoc reports as per user need

FIG. 14 illustrated the embedded linking system between the visualization of Finances, Activities, and Assets.

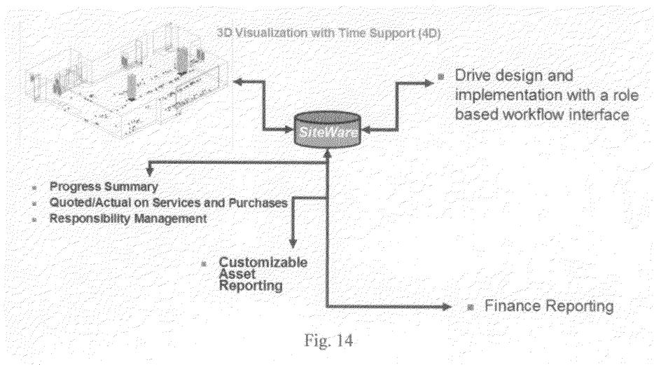

### DRAWINGS—REFERENCE NUMERALS

| | | | |
|---|---|---|---|
| 10. | BUSINESS RULES | 12. | TIME ENGINE |
| 14. | DATA REPOSITORY | 16. | ASSETS RELATIONS |
| 18. | HYPOTHERICAL SITUATIONS | 20. | INTERDEPENDENCIES |
| 22. | PHYSICAL/LOGICAL ASSETS | 24. | TIME MONITORING |
| 26. | BIDIRECTIONAL DATA FLOW | 28. | X COORDINATE |
| 30. | Y COORDINATE | 32. | Z COORDINATE |
| 34. | APPLICATIONS | | |
| | DEPENDENCIES | | |

### DETAIL DESCRIPTION

An embodiment of this invention provides a method and system for processing the information gathered to model it.

The system perceives a site in the real world through a model that encompasses all aspects of its physical and logical objects within a site, including the physical dimensions, its logical characteristics, time, business rules, behavior, relations between objects, interdependencies and characteristics of the objects.

Once this model is built within the system, the configuration of a site can be presented in multiple ways, each showing a different aspect of the site configuration. For instance, a textual representation of the hierarchical containment relations between the assets (or components) within the site can be a way of presenting the containment aspect of a site configuration. Showing a site in 3d graphics (parallel, front, top, rear, left, right view, perspective or virtual reality view) can be a way to show the 3-dimensional aspect of the site configuration. Showing a site in 3d graphics with

All physical electrical circuits highlighted, its current electrical consumption and its logical and Physical configuration can be a way of showing the electrical connectivity aspect of the site configuration.

The system displays the information providing the users a comprehensive view in Real-Time to manage physical and logical technology infrastructures and related projects in order to integrate all its elements with 3D visibility and empowering the users to see the past, present and future based on certain and customizable dynamic business rules.

In order to achieve said results, the whole system and the computer method that comprises performing at least one of the following functions:
“Current Site Viewer” Function. F1
“Future Changes” Function. F2
“Documents” Function F3
“Live Notes” Function F4
“My SiteBoard Business” Function. F5
“Administration” Function. F6
“Logical Views” Function F7
“Desktop” Function F8
“What if . . . ” Function F9
“MAC Editor” Function F10
“Reports” Function F11

### “CURRENT SITE”FUNCTION F1

The system perceives a site in the real world through a model that encompasses all aspects of its physical and logical objects within a site, including the physical dimensions, it's logical Characteristics, time, business rules, behavior, relations between objects, interdependencies and characteristics of the objects.

Once this model is built within the system, the configuration of a site can be presented in multiple ways, each showing a different aspect of the site configuration. For instance, a textual representation of the hierarchical containment relations between the assets (or components) within the site can be a way of presenting the containment aspect of a site configuration. Showing a site in 3d graphics (parallel, front, top, rear, left, right view, perspective or virtual reality view) can be a way to show the 3-dimensional aspect of the site configuration. Showing a site in 3d graphics with all physical electrical circuits highlighted, its current electrical consumption and its logical and physical configuration can be a way of showing the electrical connectivity aspect of the site configuration.

### “FUTURE CHANGES”FUNCTION F2

The system is able to capture the differences between the future model and the previous model. In addition, it can manage resource allocation, plan, follow dependencies, manage relationships, price, perform provisioning of the implementation of these differences, track the execution, and manage the verification and payment of the implementation.

The asset delta records created by a MAC (Moves, Add and Changes) Editor Function are linked with Task objects that are controlled by the project management of system.

### “DOCUMENTS”FUNCTION F3

SiteWare™ Document Manager is a document management function capable of handling the complete life cycle of documents. Documents within the document manager are internally implemented as assets. Asset can have its own customized characteristics and have the capability to link itself into specific business rules. This design enables documents to relate to other real-world assets in the same way as real-world assets relate to each other. With this design, assets can be intrinsically related to the relevant documents.

Another important characteristic of the document manager is the search capability that enables user to conveniently locate documents by searching for keywords.

### “LIVE NOTES”FUNCTION F4

Live Notes Function facilitates collaboration and communication by allowing users to create discussion forums and invite other users to participate in the discussion. Participating users are notified when new information is posted in the forum. Most importantly, Live Notes function can be related to assets, projects, project phases, work orders, quotes, and to any physical or logical asset as the user requirement, giving users a convenient way to relate threads of discussions with the objects the discussions are about.

### “MY SITEBOARD BUSINESS”FUNCTION F5

The system lets users create customizable web pages called “My SiteBoard pages”, containing information that the users consider relevant and/or important. This information in the customizable web page is delivered as instances of the system applications or the latest output of customizable reports.

The way in which the system reports can be configured by the user to run at user defined schedules. When a report is configured as such, the system automatically runs the report at the scheduled times and save its output. With this function, users can configure reports to run at optimal frequencies or schedules that reflect what the user considers as real-time, if a change occurred within the report and the user needs to be alerted, the system will start an escalation procedure in order to provide an action per specific alert.

In addition, a user can configure the system to display a selected customizable web page, or the default customizable web page, immediately after log in, in order to make important and real-time information easily accessible to him.

### “ADMINISTRATION”FUNCTION F6

The aim of this function is to empower users to configure the SiteWare engine to operate in coherence within the users' environment.

The Administration function is delivered as a number of administrative applications, which can be divided into two main categories: Asset Administration, and User Administration.

The Asset Administration functions enable users to fine tune SiteWare's perception of assets in the users' environment, covering issues such as what types of assets are in the users' environment, what are their relationships, what are their relationships with manufacturers and models, etc. The User Administration function covers issues such as managing user accounts, and user entitlement.

### “LOGICAL VIEWS”FUNCTION F7

Given a number of predefined asset groups, the system explores the relation between these groups based on connectivity data documented in its database, and present the findings in a logical diagram. These predefined asset groups may be static or dynamic. An asset group is static if it contains predefined list of assets. On the other hand, an asset group is dynamic if the members are determined by selection criteria.

In addition, this logical diagram is interactive and has the capability to link the logical representation of assets in the diagram to other system functions that have the capability to display the physical aspects of the assets.

### “DESKTOP”FUNCTION F8

The system Desktop Function provides a common space for the user to place a wide variety of dynamic, live objects, lay them out in a format that the user is familiar with, and dynamically report, explore and visualize the interrelationship between the objects.

Examples of the kinds of objects that can be placed in desktop are logical representation of assets (icons), 3-dimension graphical representation of assets, interactive applications (like a navigable view of a site), and reports (asset reports, financial report, analytical reports, and the like)

### “WHAT IF”FUNCTION F9

A predictive modeling and future scenario capability allows enterprise managers to anticipate “what if” of add or change orders, engineering change orders, technology insertions and system upgrades enhances risk mitigation and granular financial impact (what if scenarios) assessment.

Edit, Configure & Manage in real time the impacts and side effects of unexpected situations based on existing data define your own possible situations based on specific parameters

### “MAC EDITOR”FUNCTION F10

Each alteration in the future of any physical or logical asset configuration (which could be an addition of a new asset, moving an existing asset, or changing a characteristic of an asset) is tracked with an asset delta record. This asset delta record is then linked into the project management capability, which enables the implementation of this alteration to be managed under the appropriate customized process.

### “REPORTS”FUNCTION F11

The Generic Report Editor Function allows the user to specify the search criteria and result display format. Reports created with this function works in conjunction with the system report monitor.

The Logical Views Function makes use of the Generic Report Editor to create asset selection criteria for dynamic asset groups (see Logical Views).

### DETAIL DESCRIPTION OF THE INVENTION

The present invention provides a computer method and system for being able to deal with such environmental problems that comprises to carrying out at least one of the following functions.
“Current Site Viewer” Function. F1
“Future Changes” Function. F2
“Documents” Function F3
“Live Notes” Function F4
“My SiteBoard Business” Function. F5
“Administration” Function F6
“Logical Views” Function F7
“Desktop” Function F8
“What if . . . ” Function F9
“MAC Editor” Function F10
“Reports” Function F11

### CURRENT SITE FUNCTION F1

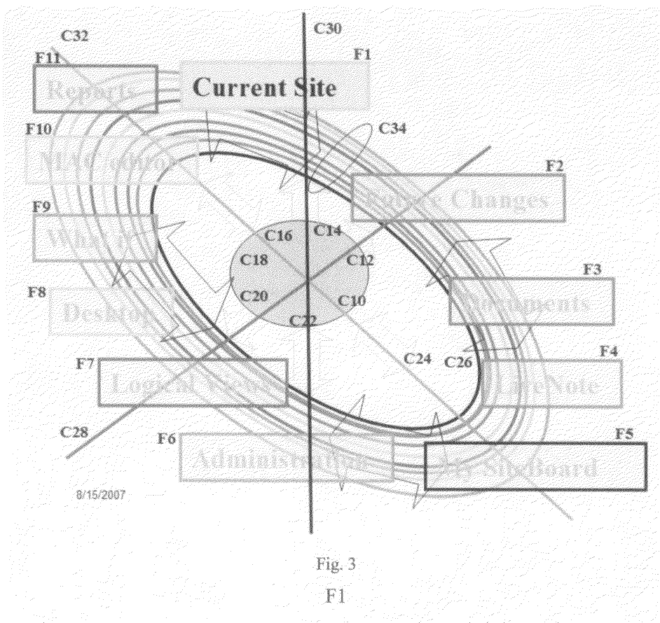

The aim of this function to present the current physical or logical site configuration, covering the trades that are of interest to the user, in a way that is easy for the user to understand, and at a level of detail definable by the user (FIG. 3).

Physical and Logical Asset relationships, physical shape and user-defined characteristics at the asset lowest level are some of the basic elements of the model that SiteWare™ uses in understanding real-world assets.

A site is broken down into physical or logical assets (or components) that constitute (or contained by) the site. Each physical or logical asset (or component) in turn are further broken down into child assets (or sub-components) representing the constituents contained by the parent asset. This process is repeated recursively until the site is broken down to a level of detail that the user considers as suitable for his environment, resulting in a hierarchy of parent and child assets. This hierarchy represents the containment relationship between the constituent assets within the site.

In addition to relating to each other in containment, physical and logical assets can relate to each other to represents other kinds of relationship, like a copper, fiber or electrical connection, or any kind of user-defined relationship.

Furthermore, each physical and logical asset has a physical shape, and user defined properties (or characteristics). SiteWare™ allows the user to configure the properties to be tracked for each type of physical or logical assets.

### With the Current Site Viewer Function, a User Can Perform the Following Actions:

### Features Included:

Edit & configure:
Initial asset hierarchy
Initial asset relationships
Enterprise baseline templates
Your templates

Visualize in a virtual world all physical and logical assets configurations

Filter information for multi trade purposes

Trace horizontal and vertical relationships

Navigate through your physical and logical assets

Depository of additional visual applications

Add live notes to an asset to start a traceable messaging chain

### FUTURE CHANGES FUNCTION F2

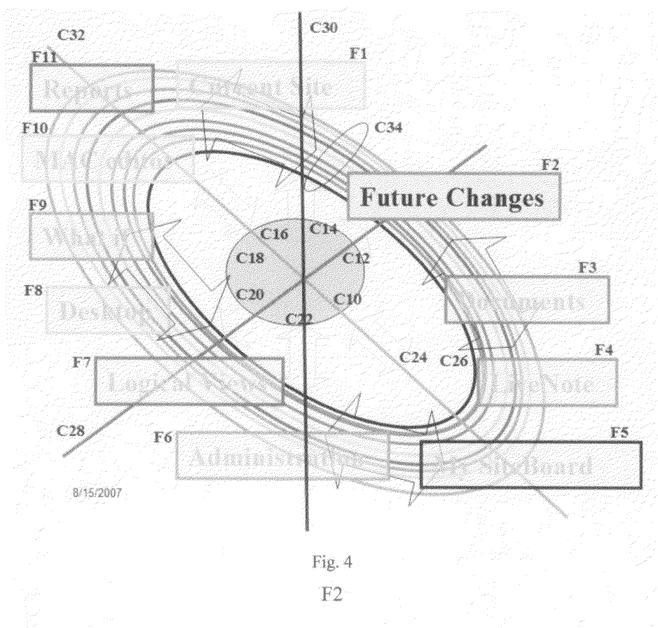

The aim of this function to build a future model of a site, capture the differences between the future model and the previous model (FIG. 4), and manage interdependencies, actions, reactions, ownership, relationships, and others for the implementation of these differences.

A Task object simply represents a unit of work that needs to be implemented. Each Task object is assigned start/end dates, resource, and a number of other user-definable properties (like quoted cost, actual cost, billable hours, actual start/end dates, actions . . . ). Tasks may have relations with other Tasks and/or assets. Tasks may also be organized such that a Task may be composed of sub-Tasks (or child Tasks). Tasks may be sequenced such that they will be implemented in a certain order. A task may be marked as a concurrent task when its sub-Tasks are required to execute concurrently. A Task may be conditional when the next task to execute depends on the outcome of a certain condition.

A Task can be put into the Task Library. It is especially helpful for repetitive jobs to be modeled as Tasks in the Task Library. This way, the steps involved in a repetitive job can be replicated in a project without having to re-create the steps for each instance of the job.

### With the Future Changes Function a User Can Perform the Following Actions:

Edit, Configure & Manage:
Projects and subprojects
Project Workflow
Project entitlements
Project Access
Work orders
Work order workflow
Quotes
Quotes Workflow
Invoices
Invoices Workflow
Activities
Activities Workflow

Visualize and monitor
Project workflow complete life cycle
In 3D format project work flow complete life cycle

Add live notes to an asset to start a traceable messaging chain

### DOCUMENTS FUNCTION F3

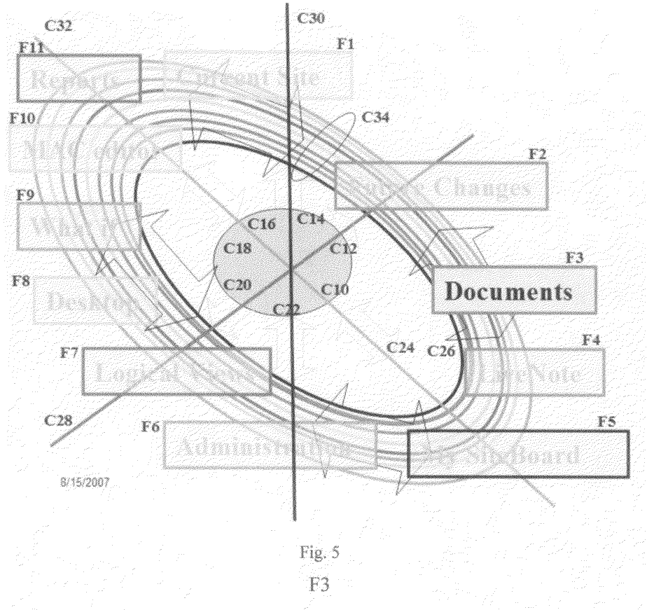

The aim of this function is to enrich the information stored in the system by linking both logical and physical assets to a document management application that contains and manages the life cycle of documents related to those assets (FIG. 5).

Documents are organized in document folders. Each folder can contain other document folders or documents. A document, in turn, contains a number of document versions. Each version may have an attachment file, which contains the actual document file version. A document can have a selection of users representing the senders of the document, the recipients of the document, and the users who are subscribed to the publication of the document. A document may be reserved for editing. When editing is complete, the author can choose to publish the document version. If the document has a list of users subscribed to document publication, then those users will be notified of the publication. The notified users can then login and download the published document version. The document manager keeps track of all documents downloads. This provides for a way to find out which users have the correct document version and which users may not.

Since documents are assets, access to documents is guarded by the same entitlement scheme that guards the access to real-world assets.

### With Documents Function, a User Can Perform the Following Actions:

Edit, Configure & Manage and attach documents to assets maintaining physical and logical information together

### LIVE NOTES FUNCTION F4

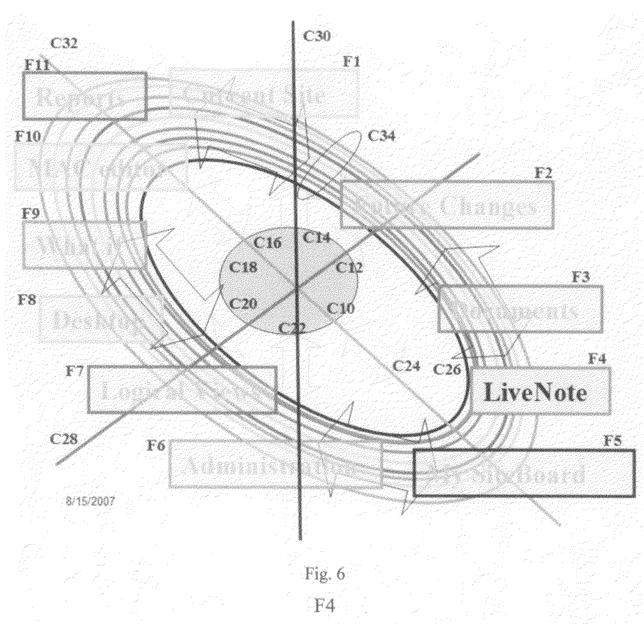

The aim of this function is to enrich the information stored in SiteWare™ by linking both physical and logical assets to all communications (notes, discussions, attachments,) pertaining to them (FIG. 6).

SiteWare™ Live Notes facilitates communication by allowing users to create discussion forums and invite other users to participate in the discussions. Participating users are notified when new information is posted in the forum.

Live Notes can be related to assets, projects, project phases, work orders, quotes, and the like which give users a convenient way to relate threads of discussions attached to the objects the discussions are about.

### With Desktop Function, a User Can Perform the Following Actions:

Edit, Configure & Manage and attach smart notes to Physical and Logical assets

Providing escalation capabilities

Tracking mechanism for message history

Maintain informed and collect messaging from multiple participants at once.

### MY SITEBOARD BUSINESS FUNCTION F5

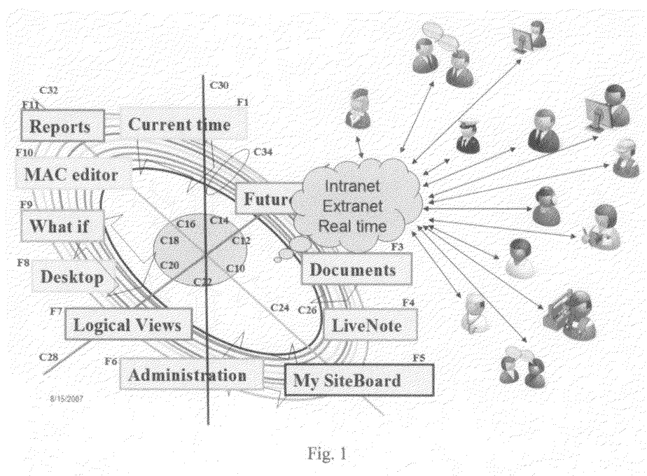

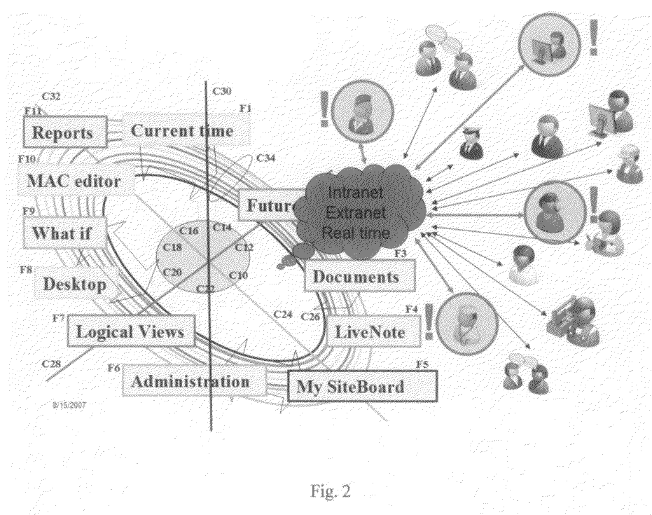

The aim of this function is to keep users aware of situations that are important to them in real-time (FIG. 1, FIG. 2).

When creating a My SiteBoard page, the user is given a list of applications that he/she is entitled to have. Based on this list of applications, the user can select the ones that he/she would like to be included in the My SiteBoard page.

A user may have multiple My SiteBoard pages, each customized to display certain kind of information.

In addition, a user can configure SiteWare™ to display a selected My SiteBoard page, or the default My SiteBoard page, immediately after log in, in order to make important and real-time information easily accessible to him.

SiteWare™ reports can be configured by the user to run at user-defined schedules. When a report is configured as such, SiteWare™ automatically runs the report at the scheduled times and save its output. With this function, a SiteWare™ user can configure his reports to run at optimal frequencies or schedules that reflect what the user considers as real-time.

By including a monitored report in a My SiteBoard page, SiteWare™ will be able to provide real-time information to the users.

### With the My SiteBoard Business Function, a User Can Perform the Following Actions:

Overall reporting application repository

Customizable area to display reports

Display
Reporting monitoring outcome
Reporting scheduling outcome
Reporting time intervals statistics
Reporting differences monitoring

Multi trade outcome analysis

Multi sites real time reports

Multi projects outcome analysis

Add live notes to reports to start a traceable messaging chain

Situation escalation

### ADMINISTRATION FUNCTION F6

The aim of this function is to empower users to configure the SiteWare engine to operate in coherence within the users' environment.

The following summarizes the asset administration functions:
Activity Type Admin—allows users to define the types of work activities in a lingo that the users are familiar with.
Asset Type Admin—allows users to define the types of assets and their properties (or characteristics) that SiteWare should be aware of when modeling the users' environment.
Asset Category Admin—allows users to aggregate asset types into categories. Asset categories are pivotal in entitlement management and other reporting functions.
Asset Type Group Admin—allows user to aggregate asset types into arbitrary groups in order to facilitate asset relationship rule management.
Code Admin—allows user to define environment specific codes (name/value pairs)
Relationship Admin—allows users to define rules that govern the relationship between asset types groups.
Manufacturer Admin—allows users to manage the manufacturers of the assets that are tracked in the SiteWare data repository.
Model Admin—allows users to manage the models of the assets that are tracked in the SiteWare data repository.
Property Field Admin—allows users to manage characteristics of asset properties.

The following summarizes the user administration functions:
Department Admin—allows user to maintain an up-to-date reflection of the users' corporate structure in SiteWare. This information is especially important to entitlement management, escalation, and reports.
Entitlement Admin—allows users to control what resources each user role may have access to. In the context of entitlement management, the term “resource” refers to objects whose access is guarded by entitlement. Gaining access to a resource means gaining access to the guarded objects. Examples of resources are assets, applications, reports, and activity types.
Person Admin—allows users to manage user accounts.
Person Group Admin—allows user to aggregate users into groups. This grouping information is mainly used to facilitate communication and collaboration. For instance, LiveNote makes use of this grouping info to enable groups of users to participate in LiveNote discussion forums.
Vendor Admin—allows users to keep track of vendors.
User Session Summary—allows users to keep track of the usage of SiteWare.

### LOGICAL VIEWS FUNCTION F7

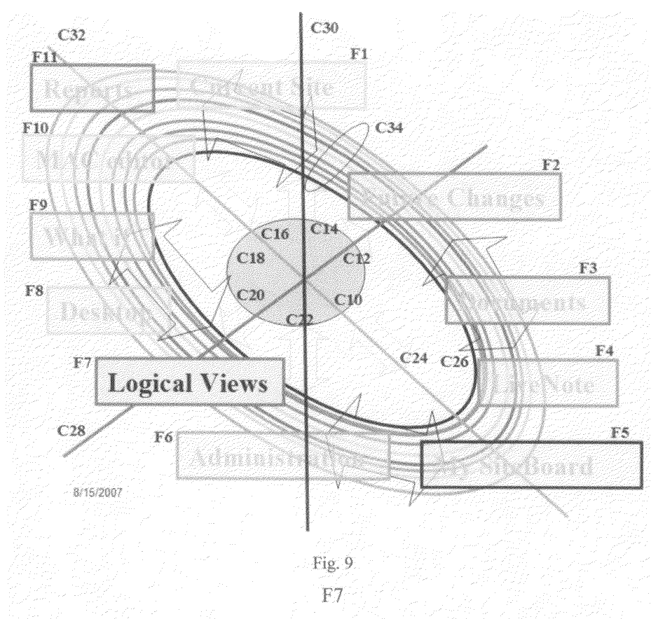

The aim of this function is to help users to understand complex site configuration by means of interactive inter-asset relation diagrams (or logical diagrams) generated from the system based on physical relationship data that is accumulated in the SiteWare™ database over time, for past, present, and future views (FIG. 9).

The configuration of a SiteWare™ logical view includes a number asset groups and a selection of relation types. This configuration can be saved under a particular name and can be retrieved and re-evaluated on demand by the user.

When evaluated, SiteWare™ finds the containment descendent assets of the assets in each asset group. Then it explores the relations between the asset groups with the selected relation types. Relations between assets and its descendents from one asset group to asset and its descendents from another asset group will be discovered by this exploration.

The result of this exploration is presented as a diagram with groups of icons representing the groups of assets, and lines joining these icons, representing asset and status of any action/reaction or relation between them.

This diagram works in conjunction with other SiteWare™ applications that is capable of showing the shape and 3-dimensional location of the assets described in the diagram.

### With Logical Views Function, a User Can Perform the Following Actions:

Edit, Configure & Manage logical views and its relationships
Logical and physical dynamic integration
Automatic update of logical visuals with its physical components
Privately or publicly visualize all logical views of your assets
Logically visualize icon status as per defined conditions happening within a period of time.

### DESKTOP FUNCTION F8

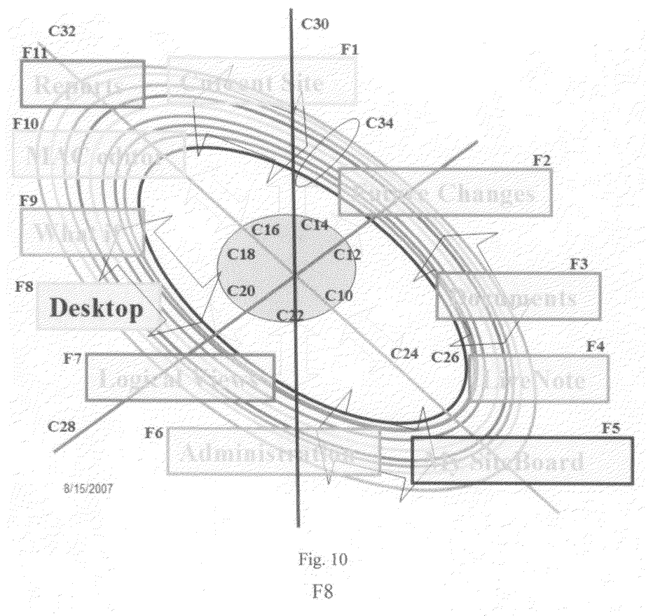

The aim of this function is to help users to improve the efficiency in understanding, communicating and manipulating data of a site configuration with an interactive environment that closely resembles the users' mental map of the site (FIG. 10).

SiteWare™ Desktop is essentially a container of objects whose size is adjustable according to the amount of objects being placed in it. Since a desktop can potentially contain a large number of objects, it is equipped with a navigation map that can be used to assist users to navigate the desktop.

The view to the user handle to look at the desktop also has the capability to zoom in, zoom out, and pan, in order to aid the visualization of the desktop.

Objects within the desktop can be rearranged by the user by selecting the objects (individually or as a group) and dragging them on the desktop.

Once objects are placed on a desktop, it has the capability to explore, request status and display the relations between the objects (according to what is documented in the SiteWare™ database). This capability essentially enables users to generate dynamic informative real-time logical diagrams.

The setup of a desktop (including the objects placed on it and their layout) can be saved and retrieved at a later time.

### With Desktop Function, a User Can Perform the Following Actions:

Edit Configure & Manage visualize others actions as well as the impact of how it would affect your domain

### WHAT IF . . . FUNCTION F9

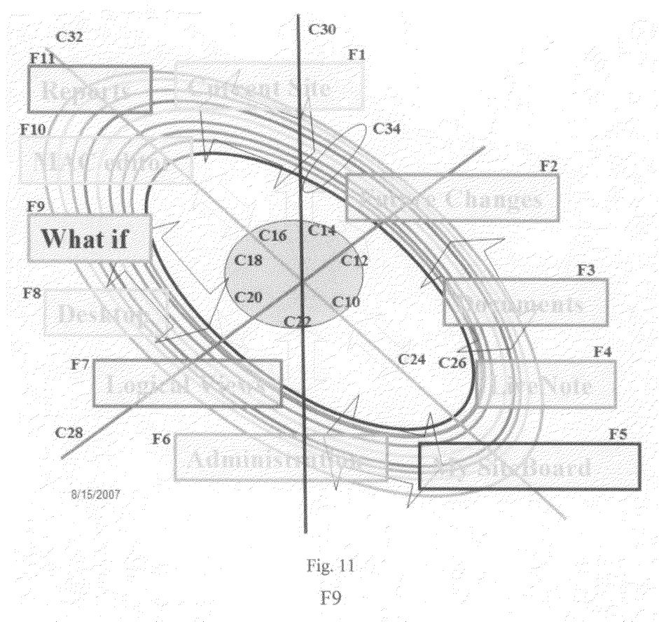

The aim of this function is to empower users to configure and adapt the system to operate in coherence with the business rules in the users' environments (FIG. 11).

A future view is ultimately built upon the current view and they are linked together by a series of asset delta's denoting the differences or alterations between the two views. If those alterations were implemented, at the end of the implementation, the current view would be transformed to what the future view was describing. Nevertheless, as long as those alterations are not implemented, the future view remains a hypothetical situation.

This characteristic of future view, when used in conjunction with analytical reports, gives users the capability to visualize and get in-depth understanding of hypothetical situations.

### With What If . . . Function and User Can Perform the Following Actions:

Edit, Configure & Manage in real time:

The impacts and side effects of unexpected situations based on existing data

Define your own possible situations based on specific parameters

### MAC EDITOR FUNCTION F10

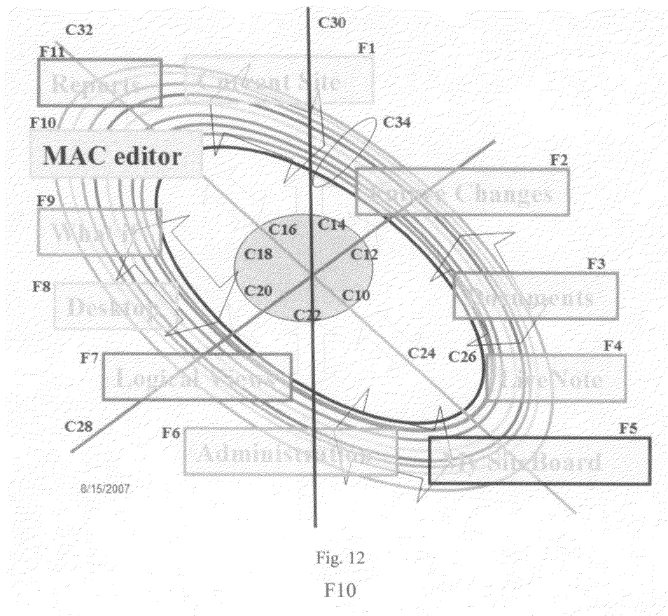

The aim of this function is to provide the user with a real-time WYSIWYG (what you see is what you get) user interface for creating changes to a future configuration in 3D virtual reality (FIG. 12).

The MAC Editor (Moves, Add & Changes) presents a site in virtual reality. It uses the concept of viewer to facilitate the virtual walk through capability that enables the user to get a real sense of the physical site.

The MAC Editor (Moves, Add & Changes) is also the launch pad for analytical reports, connectivity trace reports, and other specialized analytics, reporting, scheduling and viewing applications.

To add an asset to a site, the user may select a pre-built template from the template asset library, and then drag-and-drop it to the site. To move an asset, the user may select the asset, and then use the navigation controls to move it to the desired location. To change the characteristic of an asset, the user may select the asset and use the asset edit screen to make the alteration.

SiteWare™ has deep knowledge of assets. It is aware of their business rules, behavior and inter-dependencies. When a site configuration is altered (by adding, moving, or changing), in addition to tracking the change with asset delta records, SiteWare™ proactively revalidates the configuration. In the event if the site configuration becomes invalid, or when certain inter-dependency rules are triggered, SiteWare™ generates Tasks to track the outstanding actions needed in order to correct the site configuration or to facilitate additional changes in order for the alteration to be comprehensive.

The MAC Editor (Moves, Add & Changes) uses avatars to represent the human beings that are involved in implementing alterations. Like human beings, avatar will have physical Provisional Patent Characteristics of a human being that will be taken into consideration in the implementation of alterations.

### REPORTS FUNCTION F11

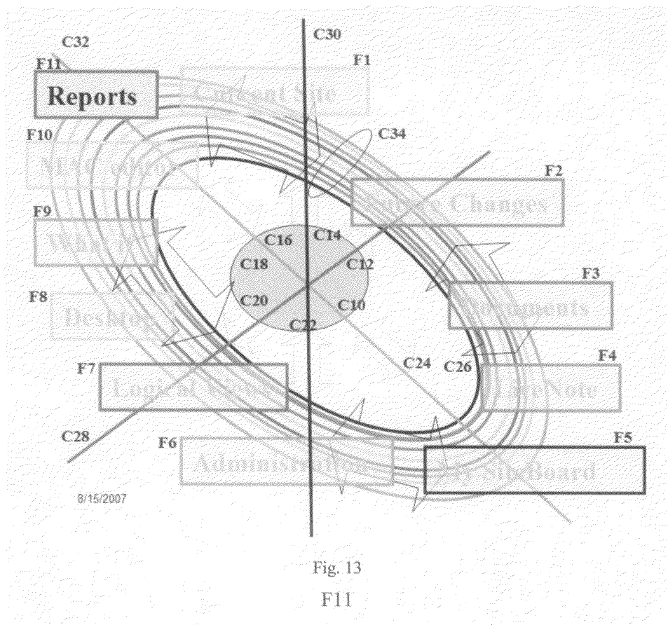

The aim of this function is to empower users to retrieve ad-hoc asset information without having to wait for the turn-around time for the development of specialized reports (FIG. 13).

The generic report editor allows users to search for assets by type and by asset properties. In addition, it can group the result by asset location or asset ownership. Alternatively, it can display the result in a grid format.

The asset search criteria and display format can be saved under a particular name and can be retrieved and executed again at a future time.

Like any report in SiteWare™, ad-hoc reports created by the generic report editor can be monitored when the report is configured to run at a user-defined schedule. SiteWare™ monitors reports by running them at the scheduled times, and compare the report output with the report output generated at the previous times when they were run. If one or more differences are found in a report, SiteWare™ will notify the report owner.

### With Reports Function, a User Can Perform the Following Actions:

Edit, Configure & Manage in real time.

Report on past, current and future deployments.

Report on properties and future relations.

What is claimed is:

1. A systemic method of computer systems modeling integration using web object oriented software computer technology enabling 3D visualization of physical and logical attributes of portfolio assets as those attributes drive business and information technology frameworks to achieve system wide awareness, consistency and discriminating definitive information sharing rules in support of detailed management of those entities, comprising the information technology of: Providing a domain relational data base resident on a network accessible on the computer desktop via a client application the object values of the entity portfolio assets generating by the computer a holistic over all 3d graphical visualization of the entity assets for the business, the overall architecture describing how the entity assets relate to each other and to the related information technology; implementing in the computer common language description in order to visually describe the overall architecture with object oriented descriptions and values associated with the business portfolio entity assets; generating by the computer 3d graphical visual representation of the overall architecture for the businesses according to a common language; determining by the 3d visualization computer information technology analysis and determination by the business in response to the computer information technology the interrelationships among the entity assets and generating by the computer an analysis and a plan for the implementation and deployment of future information technology and costs representations of the future information technology within the manageable portfolio of the entity assets based on system descriptions and rules roles of each plurality of architecture elements contained in the computer information technology definitions of the business rules and business logic; wherein the overall system architecture contains a large population of supporting information technology components including work flow process management, financial analytics, predictive modeling and metrics describing cost benefit parametric; of providing a single, logical, consistent source for all intelligent information associated within the business infrastructure for management, control, and using computer information technology for visualization of 3d logical and physical entity assets and providing 4d (time) capabilities that are related and driven by definitive business rules and logic information technology tool to display “what if” scenarios. Wherein the overall system architecture contains a plurality of computer technology components including a current site viewer functions, future change functions; document functions, live functions, my siteboard, administration function, logical view function, desktop function, what if function, Mac editor, report function.

2. The method of claim 1: wherein current site viewer functions as visualization model encompassing all aspects of physical and logical entity objects within a portfolio including physical dimensions, logical characteristics, time, business rules, behavior, interrelations, interdependencies and characteristics between entity objects; the configuration of entity objects are presented in multiple ways displaying different aspect object entity configuration, such as textual representation or 3d visualization of hierarchical containment relations between the multiple assets or components.

3. The method of claim 1: wherein the future view includes a visual graphical presentation of the differences between the future model and the previous model; it can manage resource allocation; plan and track dependencies, entity object relationships of people events and portfolio assets; track cost, pricing; execution, provisioning, verification and payment of the implementation; link asset delta records created by a MAC (Moves, Add and Changes) Editor as controlled by the project management of system.

4. The method of claim 1: wherein the document manager management function handles the complete life cycle of documents internally implemented as assets with each asset associated with customized characteristics linked to specific business rules; documents relate to real-world assets intrinsically as relevant documents with its own customized characteristics that are linked into specific business rules; and a search capability to locate documents by keyword search.

5. The method of claim 1: wherein live functions provides collaboration and communication by discussion forums that posts forum notification of new information and is related to assets, projects, project phases, work orders, quotes, and to any physical or logical entity portfolio assets with related threads of discussions.

6. The method of claim 1: wherein My SiteBoard contains relevant critical information that is customizable web page format delivered as instances of the portfolio entity asset changes or modifications with customizable reports configured to run on defined schedules or as real-time that are saved as output; configurable reports run at optimal schedules system wide to reflect critical changes to the portfolio with escalation procedure tied to action per specific alert,\; and with customizable web pages displayed system configuration immediately at log in.

7. The method of claim 1: wherein the administration function allows enhancement of asset entity perception within the portfolio across the enterprise of entity asset interrelationships and managing user accounts and entitlement.

8. The method of claim 1: wherein logical view contains predefined asset groups which explores group relationships based on connectivity documented in relevant database presented in a logical diagram as static predefined list of assets or dynamic if members are determined by selection criteria with interactive linking of the logical representation of assets to other system functions including display of physical assets aspects.

9. The method of claim 1: wherein desktop function is a common space enterprise architecture wide that is populated with dynamic, live entity objects, laid out in a familiar format that dynamically reports, explores and visualizes objects interrelationships and values; and are logical representation of entity assets visualized in a 3d graphical representation of assets, interactive applications and report generation of critical asset analytics.

10. The method of claim 1: wherein what if function configures to operate in coherence with architecture wide business rules as compared within the computer technology systems relating current view asset entities linked to visualize the differences and or changes between the present and future assets where the future view remains as an abstract predictive model of the hypothetical situation; and gives architecture enterprise capability to visualization for detailed and broad holistic understanding of hypothetical situations, to include but not limited to: editing, configuring and managing in real time enterprise architecture wide ripple effects, impacts, unforeseen dependencies and interdependencies structured around specific parameters.

11. The method of claim 1: wherein mac editor function provides real-time visualization interface to create future entity asset configuration changes as a 3d virtual reality conceptually facilitating a virtual walk through of changes and ripple effects as a view of the physical site; and analytical reports, connectivity trace reports, and numerous specialized analytics for reporting, scheduling and viewing applications; this is accomplished by drag-and-drop of selected asset entity templates from data base template library, to the desired location; each drag and drop template has relevant architecture attributes and thusly has deep knowledge of assets with awareness of relevant business rules, behavior and inter-dependencies; system wide knowledge of architecture alterations that are tracked as change within asset delta records which are automatically proactively revalidated; in instances where configurations are invalid, or when certain inter-dependency rules are triggered the computer technology generates tracking systems of outstanding actions required to correct system wide site configuration accelerate additional changes notifications for comprehensive system wide notification with intelligent agent systems to factor in human metrics of human engineering in any change implementation.

12. The method of claim 1: wherein report function supports system wide managers to retrieve ad-hoc asset information immediately in anticipation of specific business reports from administrative managers searching for assets by type and properties with grouping of results by asset location or ownership with asset search criteria and display format database retained to be retrieved and executed again by particular architecture asset managers; this includes ad-hoc reports creation and a monitored generic report editor to configure report generation at on specific schedule which are compared to system specific report output generated previously; any noted report differences are identified with formal notification provided to business component generating noted; system computer technology reports function performs report edit, configuration and management in real time with specific customized report generation of past, current and future deployments.
